(19) United States
(12) Patent Application Publication
(10) Pub. No.: US 2009/0326913 A1
(43) Pub. Date: Dec. 31, 2009

(54) MEANS AND METHOD FOR AUTOMATIC POST-EDITING OF TRANSLATIONS

(76) Inventors: Michel Simard, Gatineau (CA); Pierre Isabelle, La Peche (CA); George Foster, Ottawa (CA); Cyril Goutte, Ottawa (CA); Roland Kuhn, Ottawa (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(21) Appl. No.: 12/448,859

(22) PCT Filed: Jan. 9, 2008
(86) PCT No.: PCT/CA2008/000122

§ 371 Date: Jul. 10, 2009

Related U.S. Application Data
(60) Provisional application No. 60/879,528, filed on Jan. 10, 2007.

(51) Int. Cl. G06F 17/28

(52) U.S. Cl. 704/2

(57) ABSTRACT

The invention relates to a method and a means for automatically post-editing a translated text. A source language text is translated into an initial target language text. This initial target language text is then post-edited by an automatic post-editor into an improved target language text. The automatic post-editor is trained on a sentence aligned parallel corpus created from sentence pairs T′ and T, where T′ is an initial training translation of a source training language text, and T is second, independently derived, training translation of a source training language text.

### CROSS-REFERENCE TO RELATED APPLICATIONS

This application claims the benefit of U.S. Provisional Patent Application U.S. Ser. No. 60/879,528 filed Jan. 10, 2007, the disclosure of which is herein incorporated by reference in its entirety.

### FIELD OF THE INVENTION

This application is related to a means and a method for post-editing translations.

### BACKGROUND OF THE INVENTION

Producing translations from one human language to another (for instance, from English to French or from Chinese to English) translation is often a multi-step process. For instance, a junior, human translator may produce an initial translation that is then edited and improved by one or more experienced translators. Alternatively, some organizations may use computer software embodying machine translation technology to produce the initial translation, which is then edited by experienced human translators. In both cases, the underlying motivation is a tradeoff between cost and quality: the work of doing the initial translation can be done cheaply by using a junior, human translator or a machine translation system, while the quality of the final product is assured by having this initial draft edited by more experienced translators (whose time is more expensive).

The editing steps carried out by experienced translators to improve the quality of an initial translation made by junior human translators are sometimes called “revision”, while human editing of an initial translation produced by a machine is often called “post-editing”. However, in this document the process of improving an initial translation will be called “post-editing” in both cases—i.e., both when the initial translation was made by a human being, and when it was made by machine. Note that today's machine translation systems typically make errors when translating texts that are even moderately complex, so if the final translation is to be of high quality, the post-editing step should not be skipped in this case.

There is considerable prior art dealing with computer-assisted translation, in which a machine translation system works interactively with a human translator, thus improving the productivity of the latter. Computer-assisted translation has been explored, for instance, in the framework of the Transtype project. This project aimed at creating an environment within which a human translator can interact with a machine translation engine in real time, greatly enhancing the productivity of the human translator. A paper describing some aspects of this project is “User-friendly text prediction for translators”, George Foster, Philippe Langlais, and Guy Lapalme, in Proceedings of the Conference on Empirical Methods in Natural Language Processing, pages 148-155 (Philadelphia, USA, July 2002).

In an article from 1994 (“Automated Postediting of Documents”, in Proceedings of the National Conference on Artificial Intelligence (AAAI), 1994) Kevin Knight and Ishwar Chander have proposed the idea of an automatic adaptive posteditor that would watch a human post-edit translations, see which errors repeatedly crop up, and begin to emulate what the human is doing.

Jeffrey Allen and Christopher Hogan also discuss the idea of a postediting module that would automatically learn corrections from existing parallel tri-text (source texts; MT output; post-edited texts), in an article from 2000 (“Toward the development of a post-editing module for Machine Translation raw output: a new productivity tool for processing controlled language”, Third International Controlled Language Applications Workshop, held in Seattle, Wash., 29-30 Apr. 2000). Their paper describes a relatively simplistic application of a standard edit-distance algorithm to detect frequent corrections, that would then be re-applied systematically on new MT output.

A major economic disadvantage of the automatic post-editors proposed by Knight and Chander, and by Allen and Hogan, is that they depend on the availability of manually post-edited text. That is, these post-editors are trained on a corpus of initial translations and versions of these same translations hand-corrected by human beings. In practice, it is often difficult to obtain manually post-edited texts, particularly in the case where the initial translations are the output of a MT system: many translators dislike post-editing MT output, and will refuse to do so or charge high rates for doing so. An advantage of the current invention is that it does not depend on the availability of post-edited translations (though it may be trained on these if they are available). The automatic post-editor of the invention may be trained on two sets of translations generated independently from the same source-language documents. For instance, it may be trained on MT output from a set of source-language documents, in parallel with high-quality human translations for the same source-language documents. Thus, to train the automatic post-editor in this case, one merely needs to find a high-quality bilingual parallel corpus for the two languages of interest, and then runs the source-language portion of the corpus through the MT system of interest. Since it is typically much easier and cheaper to find or produce high-quality bilingual parallel corpora than to find manually post-edited translations, the current invention has an economic advantage over the prior art.

### SUMMARY OF THE INVENTION

It is an object of the invention to provide an automated means for post-editing translations.

One embodiment of the invention comprises in a method for creating a sentence aligned parallel corpus used in post-editing. The method comprising the following steps:

a) providing a training source-language sentence;
b) translating the training source-language sentence into a first training target-language sentence;
c) providing a second translation of said training source-language sentence called a training target-language sentence, said second training target-language sentence being independently translated from said source sentence;
d) creating a sentence pair made of said first training target-language sentence and said second training target-language sentence;
e) storing said sentence pair in a sentence aligned parallel corpus;
f) repeating steps a) to e) for one or more than additional source training-language sentence;
g) outputting the sentence aligned parallel corpus.

A further embodiment of the invention comprises a method for automatically post editing an initial translation of a source language text into a higher quality translation comprising of the steps of:

a) providing a source-language sentence;

b) translating said source-language sentence into an initial target-language sentence;

c) providing a sentence aligned parallel corpus created from one or more than one sentence pair target-language sentence, each pair comprising of a first training target-language sentence and a second independently generated training target-language sentence;

d) automatically post-editing the initial target-language sentence using a post-editor trained on said sentence aligned parallel corpus;

e) outputting from said automatic post-editing step one or more than one higher-quality target-language sentence hypotheses.

Still a further embodiment of the invention comprises a method for translating a source sentence comprising the steps:

a) providing a source language sentence;

b) translating said source language sentence into one or more than one target language sentence hypothesis using statistical machine translation;

c) translating said source language sentence into one or more than one initial target language sentence using one or more than one machine translation system;

d) post-editing said one or more than one initial target language sentence;

e) selecting from said target language sentence hypotheses and from said higher quality initial target language sentence hypotheses a final target language sentence hypothesis with the highest score;

f) outputting said final target language hypothesis sentence as said final target language sentence.

A further embodiment of the invention comprises a method for translating a source sentence into a final target sentence comprising the steps:

a) providing a source language sentence;

b) translating with a statistical machine translation system said source language sentence into one or more than one target language sentence hypothesis;

c) translating said source language sentence into one or more than one initial target language sentence;

d) post-editing said initial target language sentence with an automatic post editor to form one or more than one improved target sentence hypothesis;

e) creating a hybrid hypothesis from said one or more than one initial target language sentence hypothesis and one or more than one improved target sentence hypothesis with a recombiner;

f) selecting the hypothesis having the highest probability created by the recombiner;

g) outputting said final translation.

Yet a further embodiment of the invention comprises of a method for automatically post editing an initial translation of a source language text comprising of the steps:

a) providing a source language sentence;

b) translating said source language sentence into an initial target language sentence;

c) inputting said source language sentence and said initial target language sentence into a modified statistical machine translation decoder;

d) outputting from said decoder one or more than one hypotheses of a improved translation.

Yet a further embodiment of the invention comprises of a computer readable memory comprising a post-editor, said post-editor comprising a;
an automatic post-editing means where such a post-editing means has been trained on a sentence aligned parallel corpus trained on a first training target sentence and
a second independently generated training target sentence;
an outputting means for outputting one or more than one final target sentence hypotheses.

### BRIEF DESCRIPTION OF THE DRAWINGS

In order that the invention may be more clearly understood, embodiments thereof will now be described in detail by way of example, with reference to the accompanying drawings, in which:

FIG. 1 illustrates an embodiment for Post-Editing work flow (prior art).

FIG. 2 illustrates an embodiment of an Automatic Post-Editor.

FIG. 3 illustrates an embodiment of the current Post-Editor based on Machine Learning.

FIG. 4 illustrates an embodiment for training a Statistical Machine Translation based Automatic Post-Editor.

FIG. 5 illustrates an embodiment of a Hybrid Automatic Post-Editor.

FIG. 6 illustrates another embodiment of a Hybrid Automatic Post-Editor; simple hypothesis selection.

FIG. 7 illustrates yet another embodiment of a Hybrid Automatic Post-Editor; hypothesis selection with multiple Machine Translation Systems.

FIG. 8 illustrates yet another embodiment of a Hybrid Automatic Post-Editor; hypothesis recombination.

FIG. 9 illustrates yet another embodiment of a Hybrid Automatic Post-Editor; Statistical Machine Translation with Automatic Post-Editor based Language Model.

FIG. 10 illustrates yet another embodiment of a Hybrid Automatic Post-Editor; deeply integrated.

FIG. 11 illustrates an embodiment of the invention having multiple source languages.

FIG. 12 illustrates an embodiment of the invention having an automatic Post-Editor with Markup in Initial Translation.

### DESCRIPTION OF PREFERRED EMBODIMENTS

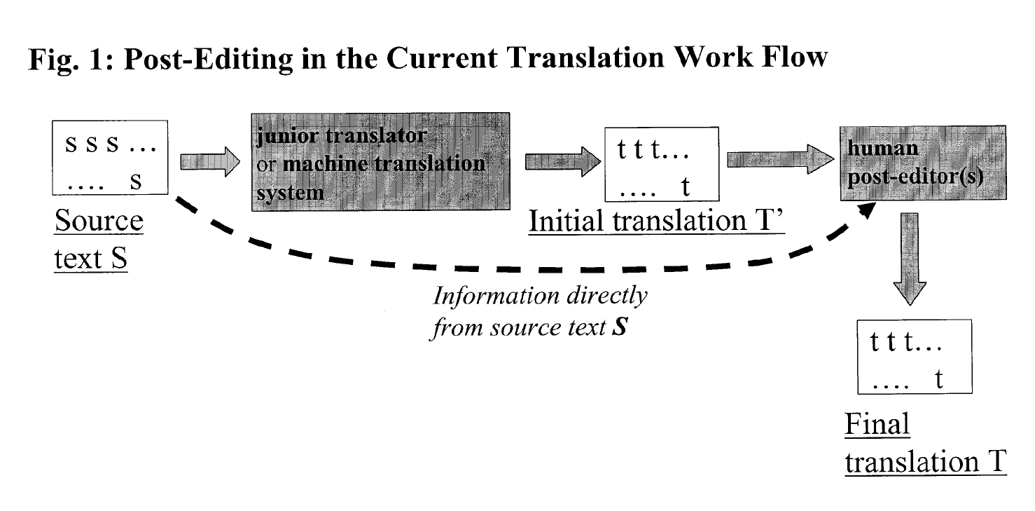

A work flow is illustrated in FIG. 1 (prior art). The original text S is in a source language, while both the initial translation T′ and the final translation T are in the target language. For instance, the source text S might be in English, while both T′ and T might be in French. Clearly, there may also be several intermediate drafts of the target-language translation between the initial version T′ and the final version T—in other words, post-editing may itself be a multi-step process. The human post-editor will mainly work with the information in the initial version T′, but may sometimes consult the source text S to be certain of the original meaning of a word or phrase in T′; this information flow from the source text to the post-editor is shown with a dotted arrow.

One embodiment of this invention performs post-editing with an automatic process, carried out by a computer-based system. This is different from standard machine translation, in which computer software translates from one human language to another. The method and system described here process an input document T′ in the target language (representing an initial translation of another document, S) to generate another document, T, in the target language (representing an improved translation of S).

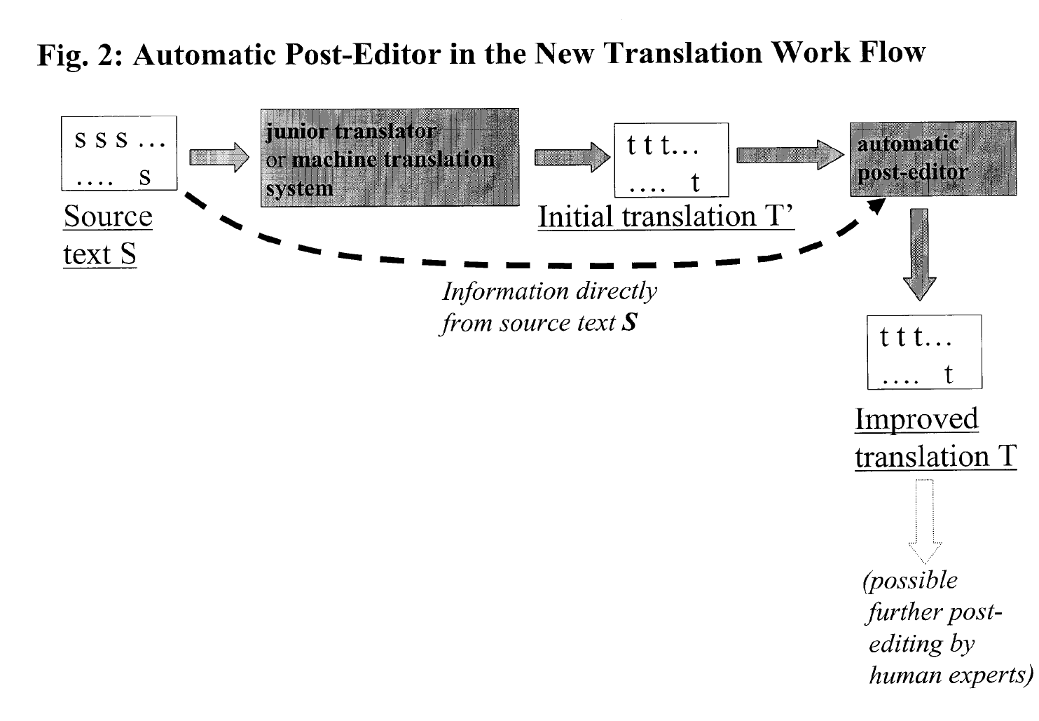

FIG. 2 illustrates how the automatic post-editor fits into the translation work flow. Note the possibility in one embodiment of the invention that the automatic post-editor incorporate information that comes directly from the source (dotted arrow).

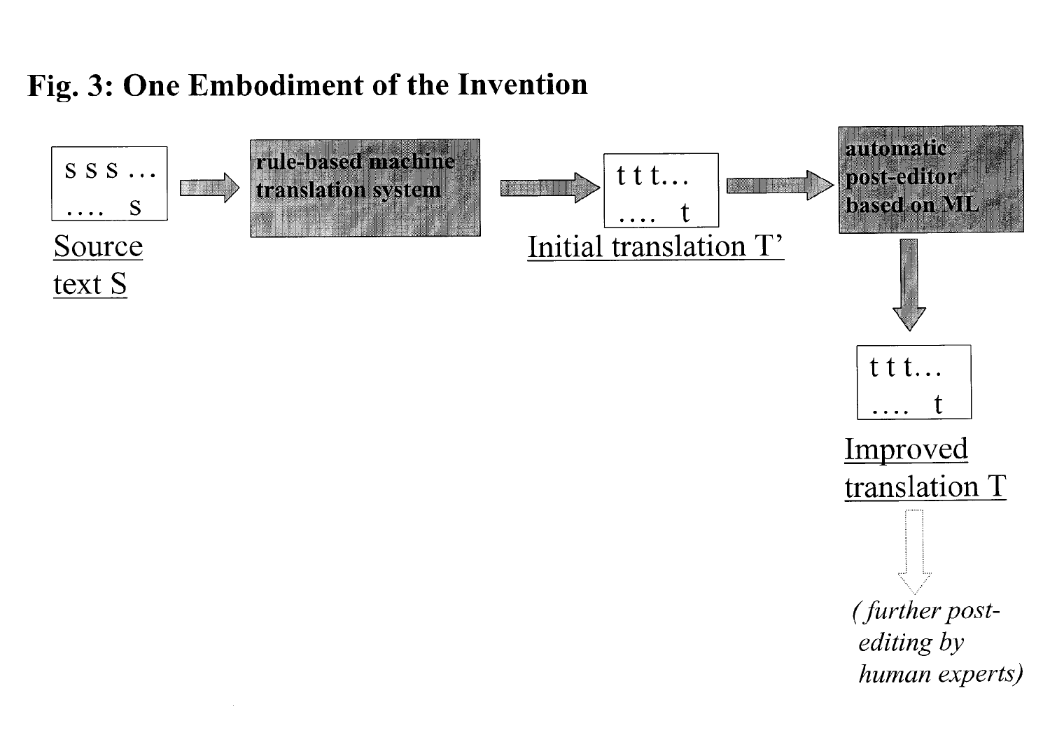

FIG. 3 illustrates one embodiment of the invention. In this embodiment, the initial translation is furnished by a “rule-based” machine translation system rather than by a human translator. Today's machine translation systems fall into two classes, “rule based” and “machine learning based”. The former incorporate large numbers of complex translation rules converted into computer software by human experts. On the other hand, the latter are designed so that they can themselves learn rules for translating from a given source language to a given target language, by estimation of a large number of parameters from a bilingual, parallel training corpus (that is, a corpus of pre-existing translations and the documents in the other language from which these translations were made). An advantage of rule based systems is that they can incorporate the complicated insights of human experts about the best way to carry out translation. An advantage of machine learning (ML) systems is that they improve as they are trained on larger and larger bilingual corpora, with little human intervention necessary.

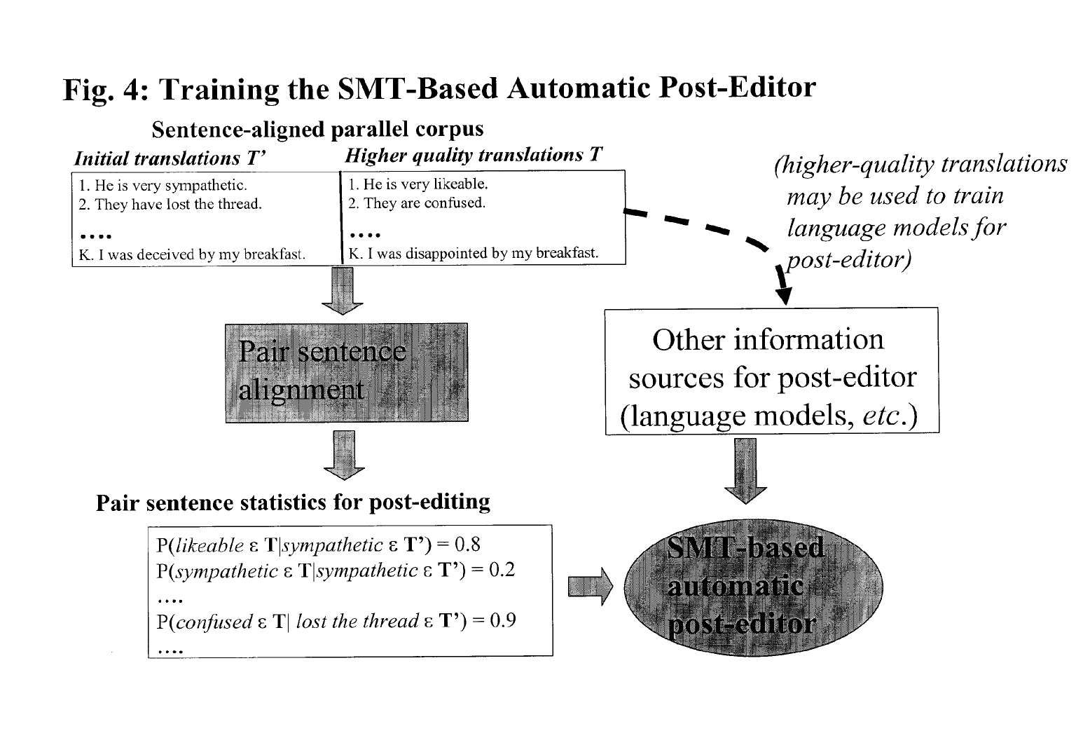

FIG. 4 illustrates how the automatic post-editor is based on machine learning (ML) technology. One of the areas of application of machine learning is statistical machine translation (SMT); this invention applies techniques from SMT, in a situation quite different from the situation in which these techniques are usually applied. The training process shown for the invention in FIG. 4 is analogous to that for SMT systems that translate between two different languages. Such systems are typically trained on “sentence-aligned” parallel bilingual corpora, consisting of sentences in the source language aligned with their translations in the target language. From these parallel bilingual corpora, a “word and phrase alignment” module extracts statistics on how frequently a word or phrase in one of the languages is translated into a given word or phrase in the other language. These statistics are used, in conjunction with information from other information sources, to carry out machine translation. In a typical SMT system, one of these other information sources is the “language model”, which specifies the most probable or legal sequences of words in the target language; the parameters of the language model may be partially or entirely estimated from target-language portions of the parallel bilingual corpora.

Rather than being trained on a bilingual parallel corpus consisting of source-language texts S and their target-language translations T, the post-editor is trained on a sentence aligned parallel corpus consisting of an initial translations T′ called a first training target language sentence, and higher-quality translations T called a second training target language sentence, of these same sentences. In the FIG. 4 example, the target language is English, and the original source language (not shown in the figure) is French. The French word “sympathique” is often mistranslated into English by inexperienced translators as “sympathetic”. In the example, a sentence whose initial translation was “He is very sympathetic” is shown as having the higher-quality translation “He is very likeable”. If the word “sympathetic” in sentences in T′ frequently corresponds to “likeable” in the corresponding sentences in T, this will be reflected in the statistics collected during word and phrase alignment of the sentence-aligned parallel corpus used to train the automatic post-editor. The result would be a tendency for the automatic post-editor trained as shown here to change “sympathetic” to “likeable” in contexts similar to those where this correspondence appeared in the sentence aligned parallel corpus. Note that one or more of the language models employed by the SMT-based automatic post-editor may be trained partially or entirely on sentences from T; this is another way in which phenomena observed in the sentence-aligned parallel corpus may influence the behaviour of the SMT-based automatic post-editor.

The corpus T may be generated in two ways: 1. it may consist of translations into the target language made independently by human beings of the same source sentences as those for which T′ are translations (i.e., T consists of translations made without consultation of the initial translations T′ called the first training target language sentence) 2. T may consist of the first training target language sentence T′ after human beings have post-edited them. As mentioned above, the latter situation is fairly uncommon and may be expensive to arrange, while the former situation can usually be arranged at low cost. Both ways of producing T have been tested experimentally; both yielded an automatic post-editor that had good performance. Clearly, a mixture of the two strategies is possible—that is, one could train the automatic post-editor on a parallel corpus where some of the sentences in T are post-edited versions of the parallel sentences in T′, and some of the other sentences in T were translated independently without consulting their counterparts in T′.

One embodiment of the invention shown in FIG. 3, where the initial translations are supplied by a rule-based machine translation system, has been tested for the French-to-English case in the context of translation of job ads between French and English (in both directions). In this embodiment, the corpus T consisted of manually post-edited versions of the initial translations in T′ (this was an example of the less common situation where manually post-edited translations happen to be available). Here are some examples of lower-case word sequences generated by this embodiment in the French-to-English direction (RBS=initial translation by rule-based system, APE=final translation output by SMT-based automatic post-editor taking RBS as input, REF=final translation generated by human expert post-editing of RBS output):

### EXAMPLE 1

RBS: to carry out the move of machinery by means of a truck has platform, (base in mechanics an asset ) advantage social
APE: to move machinery using a platform truck has, (basic mechanics an asset) benefits
REF: move machinery using a platform truck, (basic knowledge in mechanics an asset); benefits.

### EXAMPLE 2

RBS: under the responsibility of the cook: participate in the preparation and in the service of the meals; assist the cook in the whole of related duties the good operation of the operations of the kitchen.
APE: under the responsibility of the cook: help prepare and serve meals; assist the cook all of related smooth operations in the kitchen.
REF: under the cook: help prepare and serve meals; assist the cook with operations in the kitchen.

### EXAMPLE 3

RBS: make the delivery and the installation of furniture; carry out works of handling of furniture in the warehouse and on the floor
APE: deliver and install furniture; tasks handling furniture in the warehouse and on the floor.
REF: deliver and install furniture; handle furniture in the warehouse and on the showroom floor.

It is apparent that the output from the APE is much closer to the desired REF output than was the original RBS output.

An obvious question is: wouldn't it be simpler to use SMT technology to learn directly rules for translating from French to English (or vice versa), rather than training a system to repair mistakes made by another machine translation system? In the context of the job ads task, experiments were made to see which of three approaches performed better: translating the source text with an RBS (the original approach), translating the source text with an SMT trained on a corpus of parallel source language—target language sentences, or translating the source text with an RBS whose output is then post-edited by the SMT-based automatic post-editor trained on the appropriate parallel corpus (initial RBS-generated translations and versions of the same translations post-edited by humans). To avoid bias, the test data were sentences that had not been used for training any of the systems, and the two parallel corpora used for training in the last two approaches were of the same size. In these experiments, RBS translation followed by application of the automatic post-editor generated better translations than the other two approaches—that is, translations leaving the automatic post-editor required significantly less subsequent manual editing than did those from the other two approaches. Thus, the automatic post-editor of the invention was able to combine the advantages of a pure rule-based machine translation system and a conventional SMT system.

The English-French translation experiments illustrated another advantage of the invention. One version of the rule-based system (RBS) was designed for generic English-French translation tasks, rather than for the domain of job ads. By training an automatic post-editor on a small number of better-quality translations of job ads, it proved possible to obtain translations of new source texts in the job ad domain that were of better quality than the output of another version of the same RBS whose rules had been manually rewritten to be specialized to the job ads domain. Rewriting a RBS to specialize it to a given task domain is a difficult task that requires many hours of effort by human programmers. Thus, an embodiment of the invention provides an economically effective way of quickly customizing a generic MT system to a specialized domain, provided some domain-relevant training data for the automatic post-editor is available.

An independent set of experiments tested the invention in the context of English-to-Chinese translation. Again, the initial translations were produced by a mainly rule-based commercial machine translation system (using completely different algorithms and software than the rule-based system in the previously described experiments). For these experiments, post-edited versions of translations produced by the rule-based system were unavailable. Instead, the sentence-aligned corpus used to train the automatic post-editor consisted of English translations T′ produced by the rule-based system for a set of Chinese sentences, and English translations T of the same Chinese sentences produced independently by experienced human translators. Thus, this is an example of the more common situation where independently produced translations, rather than manually post-edited translations, are used to train the automatic post-editor. Just as with the French-English experiments, the English translations produced by the automatic post-editor operating on the output of the rule-based system (on new test Chinese sentences) were of significantly higher quality than these initial translations themselves, and also of significantly higher quality than English translations produced from the Chinese test sentences by an SMT system. The SMT system in this comparison was trained on a parallel Chinese-English corpus of the same size and coverage as the corpus used to train the automatic post-editor.

One embodiment of the invention is based on phrase-based statistical machine translation (phrase-based SMT). Phrase-based SMT permits rules for translation from one “sublanguage” to another to be learned from a parallel corpus. Here, the two sublanguages are two different kinds of translations from the original source language to the target language: the initial translations, and the improved translations. However, the techniques of phrase-based SMT were originally developed to translate not between sublanguages of the same language (which is how they are applied in the invention), but between genuinely different languages, such as French and English or English and Chinese.

Important early work on statistical machine translation (SMT), preceding the development of phrase-based SMT, was carried out by researchers at IBM in the 1990's. These researchers developed a set of mathematical models for machine translation now collectively known in the machine translation research community as the “IBM models”, which are defined in “The Mathematics of Statistical Machine Translation: Parameter Estimation” by P. Brown et al., Computational Linguistics, June 1993, V. 19, no. 2, pp. 263-312. Henceforth, the expression “IBM models” in this document will refer to the mathematical models defined in this article by P. Brown et al.

Though mathematically powerful, these IBM models have some key drawbacks compared to today's phrase-based models. They are computationally expensive, both at the training step (when their parameters are calculated from training data) and when being used to carry out translation. Another disadvantage is that they allow a single word in one language to generate zero, one, or many words in the other language, but do not permit several words in one language to generate, as a group, any number of words in the other language. In other words, the IBM models allow one-to-many generation, but not many-to-many generation, while the phrase-based models allow both one-to-many generation and many-to-many generation.

Phrase-based machine translation based on joint probabilities is described in “A Phrase-Based, Joint Probability Model for Statistical Machine Translation” by D. Marcu and W. Wong in Empirical Methods in Natural Language Processing, (University of Pennsylvania, July 2002); a slightly different form of phrase-based machine translation based on conditional probabilities is described in “Statistical Phrase-Based Translation” by P. Koehn, F.-J. Och, and D. Marcu in Proceedings of the North American Chapter of the Association for Computational Linguistics, 2003, pp. 127-133. In these documents, a “phrase” can be any sequence of contiguous words in a source-language or target-language sentence.

Another recent trend in the machine translation literature has been recombination of multiple target-language translation hypotheses from different machine translation systems to obtain new hypotheses that are better than their “parent” hypotheses. A recent paper on this topic is “Computing Consensus Translation for Multiple Machine Translation Systems Using Enhanced Hypothesis Alignment”, by E. Matusov, N. Ueffing, and H. Ney, in Proceedings of the EACL, pp. 263-270, 2006.

Although this embodiment of the invention employs phrase-based SMT, the invention is also applicable in the context of other approaches. For instance, the invention is also applicable to machine translation based on the IBM models. It is also applicable to systems in which groups of words in the source sentences (the initial translations) have been transformed in some way prior to translation. Thus, it is applicable to systems in which some groups of words have been replaced by a structure indicating the presence of a given type of information or syntactic structure (e.g., a number, name, or date), including systems where such structures can cover originally non-contiguous words.

To understand the mathematics of SMT, let S represent a sentence in the source language (the language from which it is desired to translate) and T represent its translation in the target language. According to Bayes's Theorem, we can show for fixed S that the conditional probability of the target sentence T given the source, P(T|S), is proportional to P(S|T)*P(T). Thus, the earliest SMT systems (those implemented at IBM in the 1990s) sought to find a target-language sentence T that maximizes the product P(S|T)*P(T). Here P(S|T) is the so-called “backward translation probability” and P(T) is the so-called “language model”, a statistical estimate of the probability of a given sequence of words in the target language. The parameters of the language model are estimated from large text corpora written in target language T. The parameters of the target-to-source translation model P(S|T) are estimated from a parallel bilingual corpus, in which each sentence expressed in the source language is aligned with its translation in the target language.

Today's systems do not function in a fundamentally different way from these 1990s IBM systems, although the details of the P(S|T) model are often somewhat different, and other sources of information are often combined with the information from P(S|T) and P(T) in what is called a loglinear combination. Often, one of these other sources of information is the “forward translation probability” P(T|S).

Thus, instead of finding a T that maximizes P(S|T)*P(T), today's SMT systems are often designed to search for a T that maximizes a function of the form P(S|T)^{α1}*P(T|S)^{α2}*P(T)^{α3}*g₁(S,T)^{β1}*g₂(S,T)^{β2}*_{. .} *gₖ(S,T)^{βK}*h₁(T)^{δ1}*h₂(T)^{δ2}*_{. .}*h_{L}(T)^{67 L}, where the functions gᵢ( ) generate a score based on both source sentence S and each target hypothesis T, and functions hj( ) assess the quality of each T based on unilingual target-language information. Just as was done in the 1990s IBM systems, the parameters of P(S|T) and P(T) are typically estimated from bilingual parallel corpora and unilingual target-language text respectively. The parameters for functions gᵢ( ) are sometimes estimated from bilingual parallel corpora and sometimes set by a human designer; the functions hⱼ( ) are sometimes estimated from target-language corpora and sometimes set by a human designer (and of course, a mixture of all these strategies is possible). It is apparent that this functional form, called “loglinear combination”, allows great flexibility in combining information sources for SMT. A variety of estimation procedures for calculating the loglinear weights are described in the technical literature; a very effective estimation procedure is described in “Minimum Error Rate Training for Statistical Machine Translation” by Franz Josef Och, Proceedings of the 41st Annual Meeting of the Association for Computational Linguistics, 2003.

In phrase-based SMT, information about “forward” and “backward” translation probabilities is sometimes represented in a “phrase table”, which gives the conditional probabilities that a given phrase (short sequence of words) in one language will correspond to a given phrase in the other language. For instance, the “forward” phrase table shown in the lower left hand corner of FIG. 4 gives the probability of phrases in the “post-edited translation” sublanguage, given the occurrence of certain phrases in the “initial translation” sublanguage. In this example, the probability that an occurrence of “sympathetic” in an initial translation will be replaced by “likeable” in the post-edited translation has been estimated as 0.8.

A final detail about today's phrase-based SMT systems is that they are often capable of two-pass translation. The first pass yields a number of target-language hypotheses for each source-language sentence that is input to the system; these hypotheses may be represented, for instance, as a list (“N-best list”) or as a lattice. The second pass traverses the list or the lattice and extracts a single, best translation hypothesis. The underlying rationale for the two-pass procedure is that there may be information sources for scoring hypotheses that are expensive to compute over a large number of hypotheses, or that can only be computed on a hypothesis that is complete. These “expensive” information sources can be reserved for the second pass, where a small number of complete hypotheses need to be considered. Thus, in the first pass only “cheap” information sources are used to score the hypotheses being generated, while in the second pass both the “cheap” and the “expensive” information sources are applied. Since in the first pass search through the space of possible hypotheses is carried out by a component called the “decoder”, the first pass is often called “decoding”, while the second pass is often called “rescoring”.

Above, it was mentioned that the phrase-based embodiment has been tested in the context of automatic post-edition of rule based machine translations, between English and French (both directions) and Chinese to English (one direction). In the English-French case, two systems were built, one carrying out post-edition of English translations of French-language job ads, and one carrying out post-edition of French translations of English-language job ads. A variety of feature functions were used for the first pass of translation, and for rescoring. For instance, the system for post-editing English translations of French ads employed forward and backward phrase tables trained on the corpus of initial RBS translations in parallel with a final, post-edited (by humans) version of each of these translations, two language models for English (one trained on final translations into English, one on English sentences from the Hansard corpus of parliamentary proceedings), a sentence length feature function, a word reordering feature function, and so on. The feature functions used for the Chinese-to-English system were of a similar nature, though the corpora used were different.

In the two sets of experiments described earlier, there was no direct information flow between the source text and the automatic post-editor. That is, the arrow with dashes shown in FIG. 2 was missing. In this respect, the embodiment illustrated in FIG. 3 does not fully reflect the practice of a human post-editor, since a human post-editor may consult the source text from time to time (especially in cases where the mistakes made during the initial translation are sufficiently serious that the meaning of the original cannot be recovered from the initial translation). The next section describes an embodiment of the invention in which the automatic post-editor combines information from the source and from an initial translation. To simplify the nomenclature, automatic post-editors that combine information from the source document and from initial translations will henceforth be called “hybrid automatic post-editors”, because they incorporate an element of machine translation into the automatic post-editing functionality.

### Hybrid Automatic Post-Editor (Hybrid APE)

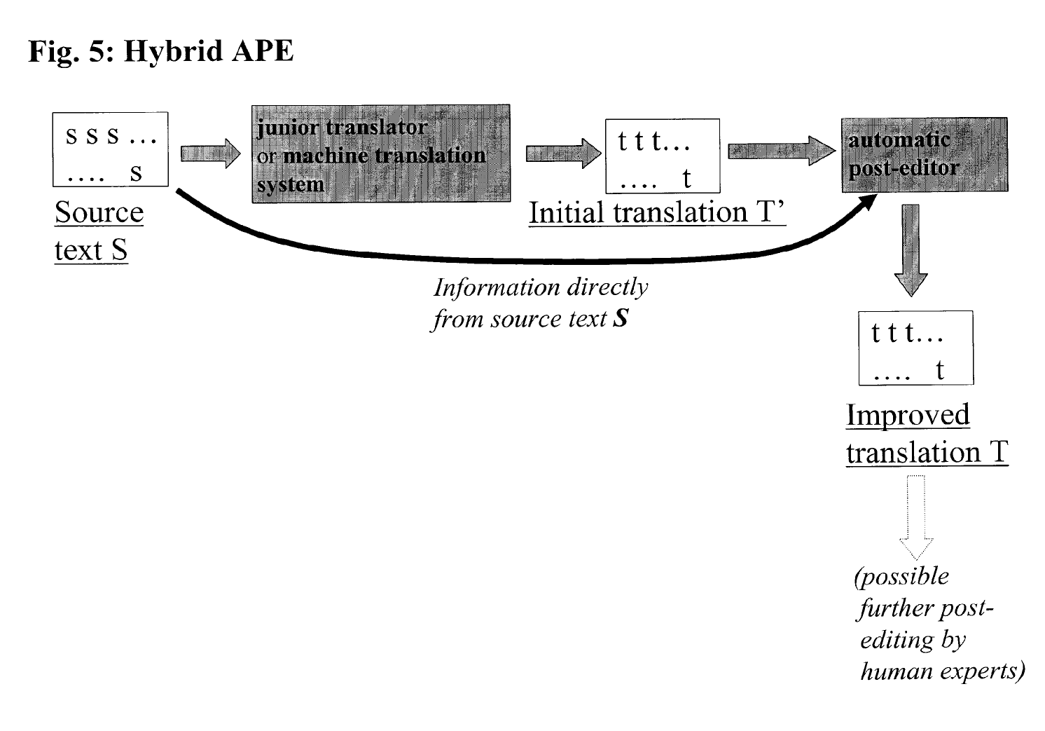

In FIG. 5 the automatic post-editor that combines information from the source text and the initial translation (hybrid APE) is shown. This figure is the same as FIG. 2, except that now the flow of information from the source text to the APE is no longer optional.

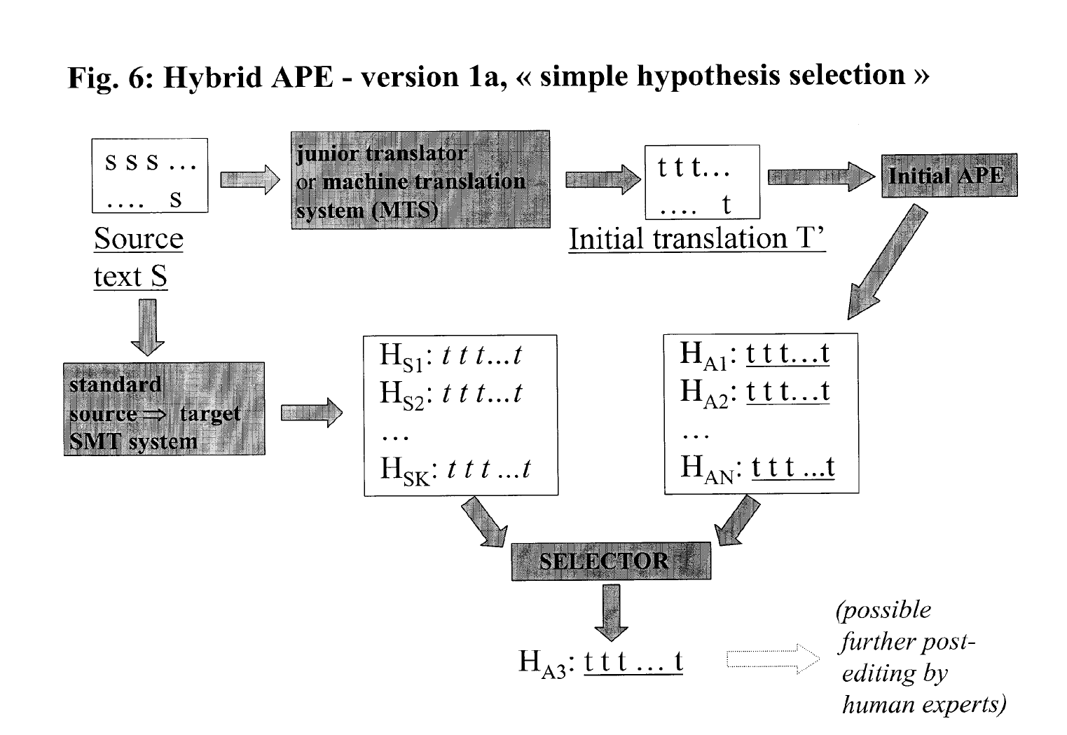

There are several different ways of combining information from an initial translation with information coming directly from the source text. The arrangement shown in FIG. 6 is one of the simplest. Let a standard SMT generate K translations into the target language from each source sentence, outputting one or more than one target language sentence hypotheses and let an initial APE of the simple, non-hybrid type described above generate N hypotheses from an initial translation called an improved initial target language sentence (produced by another kind of MT system or by a junior translator). A “selector” module then chooses a particular hypothesis called the final target language hypothesis sentence from the K+N pooled hypotheses as the output of the hybrid APE. Thus, for each sentence in the source text, the selector may choose either a translation hypothesis output by the initial APE or a hypothesis generated by the standard SMT system.

There are many different ways of designing the selector module. It could, for instance, incorporate a probabilistic N-gram target language model trained on large amounts of data; the chosen hypothesis could then be the hypothesis originating from either “branch” of the system that yields the highest language model probability. However, more complex heuristics are possible. For instance, the selector module may use a scoring formula that incorporates the scores assigned to each hypothesis by the module that produced it (the initial APE or the standard SMT system). This formula may weight scores coming from different modules differently (since some modules may produce more reliable scores); the formula could also give a scoring “bonus” to hypotheses that appear on both lists.

The formula could incorporate a language model probability.

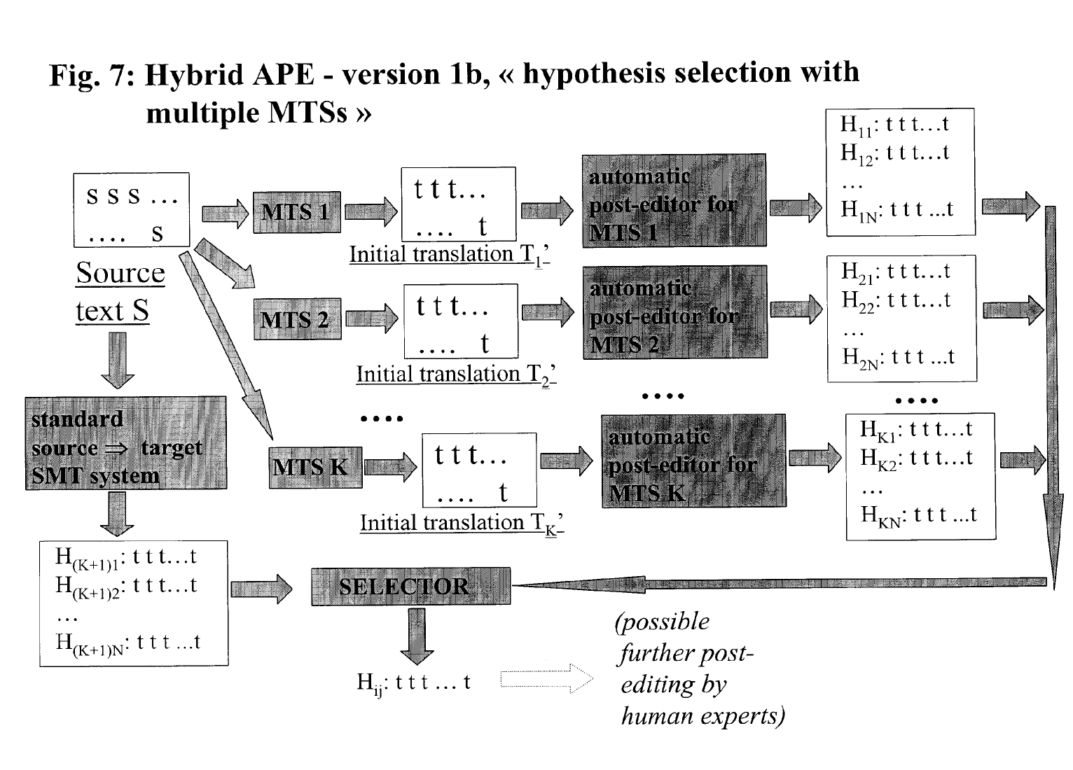

The scheme in FIG. 7 shows an extension of the FIG. 6 scheme to the case of an arbitrary number of modules that produce initial translations. In particular, if one wished to combine the automatically post-edited output of several different machine translation systems (MTSs), this would be one way to do it. Note that each MTS is shown here as having its own dedicated initial APE, allowing each initial APE to learn from training data how to correct the errors and biases of its specific MTS. However, one could also train a single initial APE that handled output from all the MTSs, for a gain in simplicity and a possible loss in specificity.

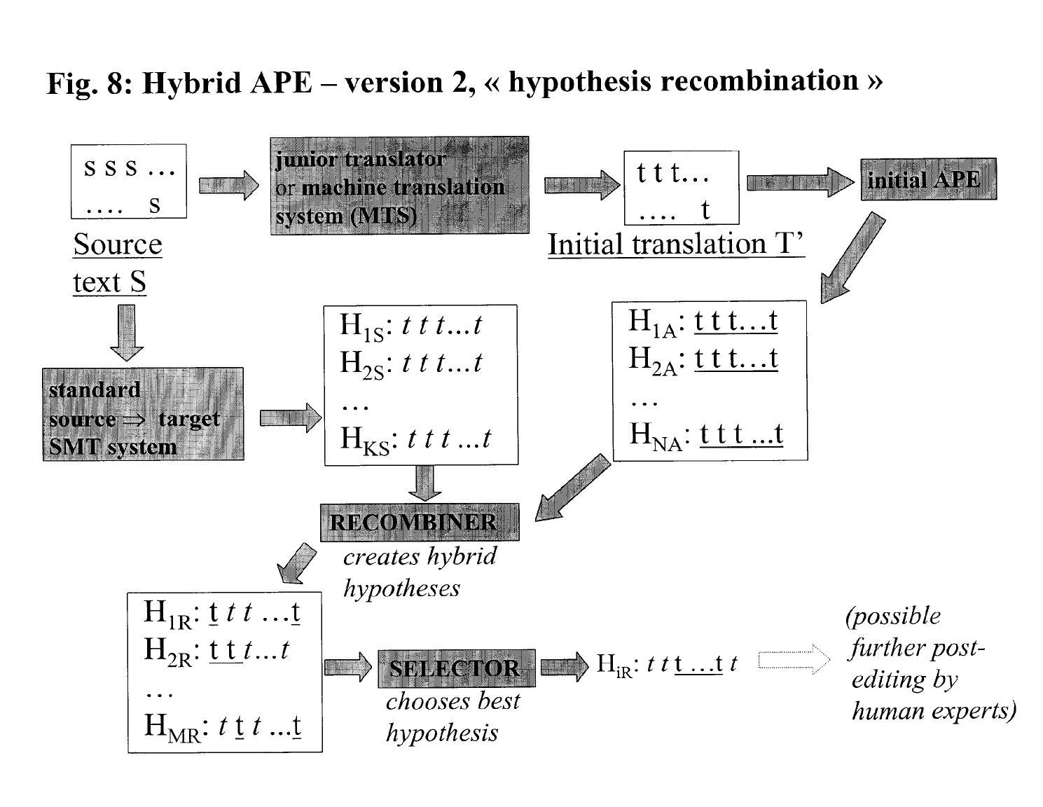

Another embodiment of the invention permits the system to combine information from different hypotheses. This embodiment is illustrated in FIG. 8, where a “recombiner” module creates hybrid hypotheses whose word subsequences may come from several different hypotheses. A selector module then chooses from the output of the recombiner. As stated earlier the operation of a recombiner has been explained in the publication “Computing Consensus Translation for Multiple Machine Translation Systems Using Enhanced Hypothesis Alignment”, by E. Matusov, N. Ueffing, and H. Ney, in Proceedings of the EACL, pp. 263-270, 2006. Thus, if (for instance) the first half of a source sentence is well translated by output from the initial APE, but the second half of the source sentence receives a more accurate translation from the standard SMT system, a final hypothesis whose first half was generated by the initial APE and whose second half was generated by the standard SMT system may be the final translation output by the overall system. Just as FIG. 7 shows a “multiple MTS” version of the scheme in FIG. 6, so a “multiple MTS” version of the FIG. 8 scheme is possible. This “multiple MTS hypothesis recombination” scheme might, for instance, be a good way of combining information from several different rule-based MTSs with information from a standard SMT system.

To make the diagrams easier to understand, FIGS. 6-8 all show the output of the initial APEs and of the standard SMT system as being in the form of an N-best list. However, these figures and the descriptions given above of the combination schemes they represent also apply to the case where some or all of the initial APEs and the standard SMT systems produce output in the form of a lattice of hypotheses.

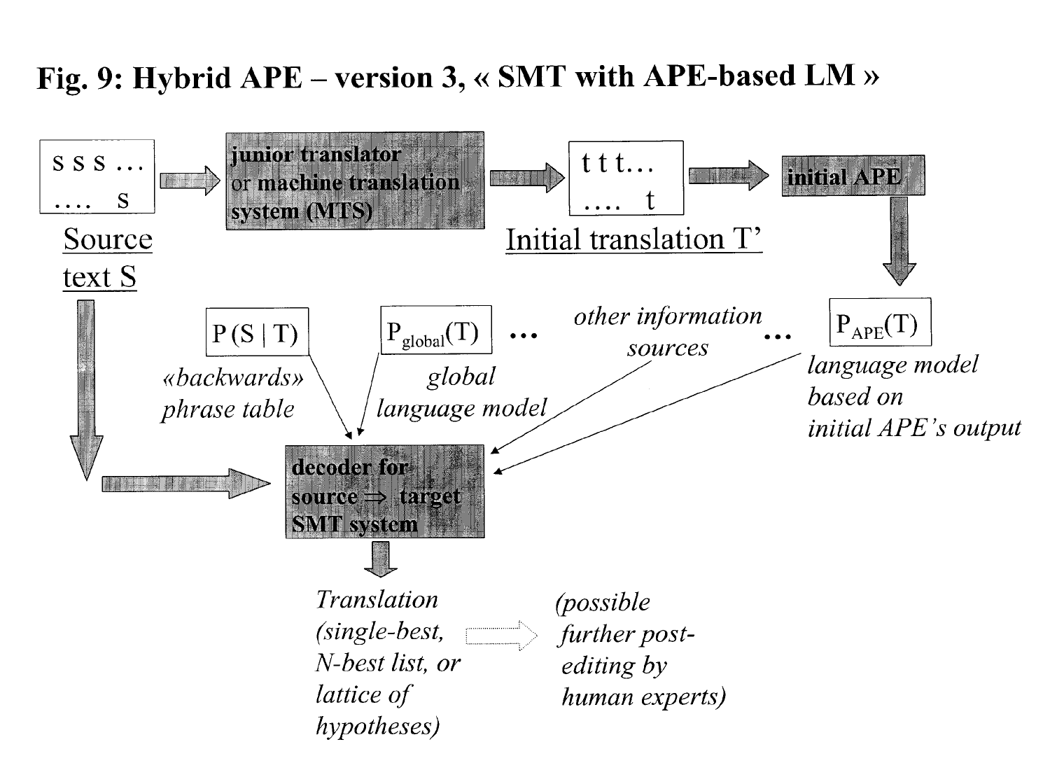

In yet another embodiment of the invention information from the initial APE is integrated with the information from the direct SMT while hypotheses are being generated, rather than afterwards. One way of achieving this tighter integration is shown in FIG. 9. Here, the output from the initial APE is used to generate a target language model P_{APE}(T). In the probabilistic N-gram language model framework, this is straightforward. For instance, the initial APE could generate a list of hypothesized translations for the current source sentence; P_{APE}(T) can be estimated from the N-gram counts extracted from this corpus. Alternatively, P_{APE}(T) could be estimated from a translation lattice output by the initial APE.

This language model P_{APE}(T) can then be used as an additional information source in the loglinear combination used to score hypotheses being generated by the direct SMT component. This allows the overall system (i.e., the hybrid APE) to favor hypotheses than contain N-grams that are assigned high probability by the initial APE's translations of the current source sentence. Note from FIG. 9 that P_{APE}(T) should probably not be the only language model used by the SMT system's decoder (if it were, the output could never contain N-grams not supplied by the initial APE). As with the hybrid APEs described earlier, this type is easily extensible to combination of multiple machine translation systems. This kind of hybrid APE is asymmetrical: the initial APE supplies a language model, but not a phrase table. A mirror-image version is also possible: here it is the direct SMT system that supplies a language model to an SMT-based APE “revising” initial translations.

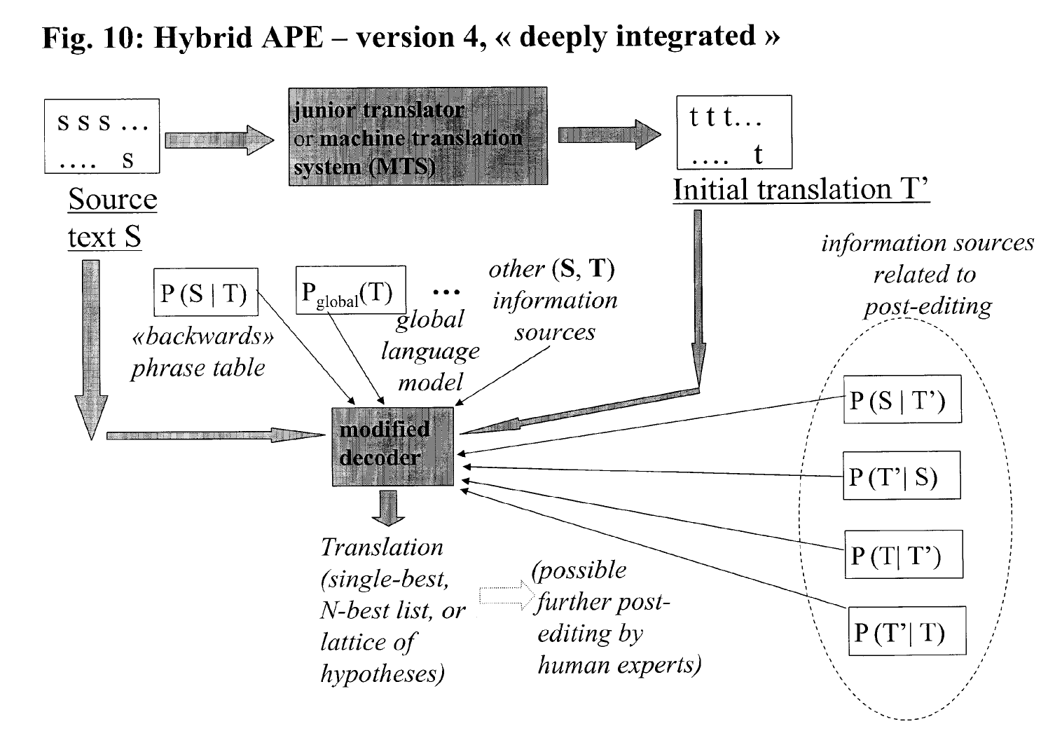

Finally, one can construct a hybrid APE with an even deeper form of integration, in which the decoder has access to phrase tables associated with both “paths” for translation (the direct path via a standard source-to-target SMT and the indirect path via an initial translation which is subsequently post-edited by an initial APE). This “deeply integrated” hybrid APE requires a modified SMT decoder. A conventional phrase-based SMT decoder for translating a source language sentence S to a target language sentence T “consumes” words in S as it builds each target language hypothesis. That is, it crosses off words in S that have already been translated, and will only seek translations for the remaining words in S. FIG. 10 illustrates a modified decoder for the deeply integrated hybrid APE, which must “consume” two sentences as it constructs each target language hypothesis: not only the original source sentence S, but also an initial translation T′ for S produced (for instance) by a rule-based machine translation system. To do this, it consults models relating initial translations T′ to the source S and to the final translation T. As target-language words are added to a hypothesis, the corresponding words in S and T′ are “consumed”; the words consumed in S should correspond to the words consumed in T′. Thus, a scoring “bonus” will be awarded (explicitly or implicitly) to hypotheses T that “consume” most of the words in S and T′, and most of whose words can be “accounted for” by the words in S and T′. As with the hybrid APEs described above, the deeply integrated hybrid APE may take as input several initial translation hypotheses.

Another possible “deeply integrated” hybrid APE would involve a three-way phrase table, constructed during system training and containing phrase triplets of the form (s, t′, t, phrase_score), where s is a source phrase, t′ is a phrase in the initial hypothesis, t is a phrase from high-quality target text, and phrase_score is a numerical value. During decoding, when a hypothesis H “consumes” phrase s by inserting t in the growing hypothesis, the score phrase_score is incorporated in the global score for H if and only if initial translation T′ contains an unconsumed phrase t′. If and only if this is the case, t′ is “consumed” in T′. If no matching triplet is available, the decoder could “back off” to a permissible doublet (s, t), but assign a penalty to the resulting hypothesis. Another possibility for dealing with cases of being unable to match triplets is to allow “fuzzy matches” with the t′ components of such triplets, where a “fuzzy match” is a partial match (the most information-rich words in the two sequences match, but perhaps not all words match).

Yet another type of hybrid APE would involve a first, decoding pass using only the direct SMT system. This pass would generate an N-best list; elements of the list that matched the outputs of the initial APE would receive a scoring bonus.

The examples of hybrid APEs above illustrate the point that there are many ways to construct a hybrid APE, which cannot all be enumerated here. Note that hybrid APEs offer an extremely effective way of combining information relevant to the production of high-quality translations from a variety of specialized or generic machine translation systems and from a variety of data, such as translations or post-edited translations.

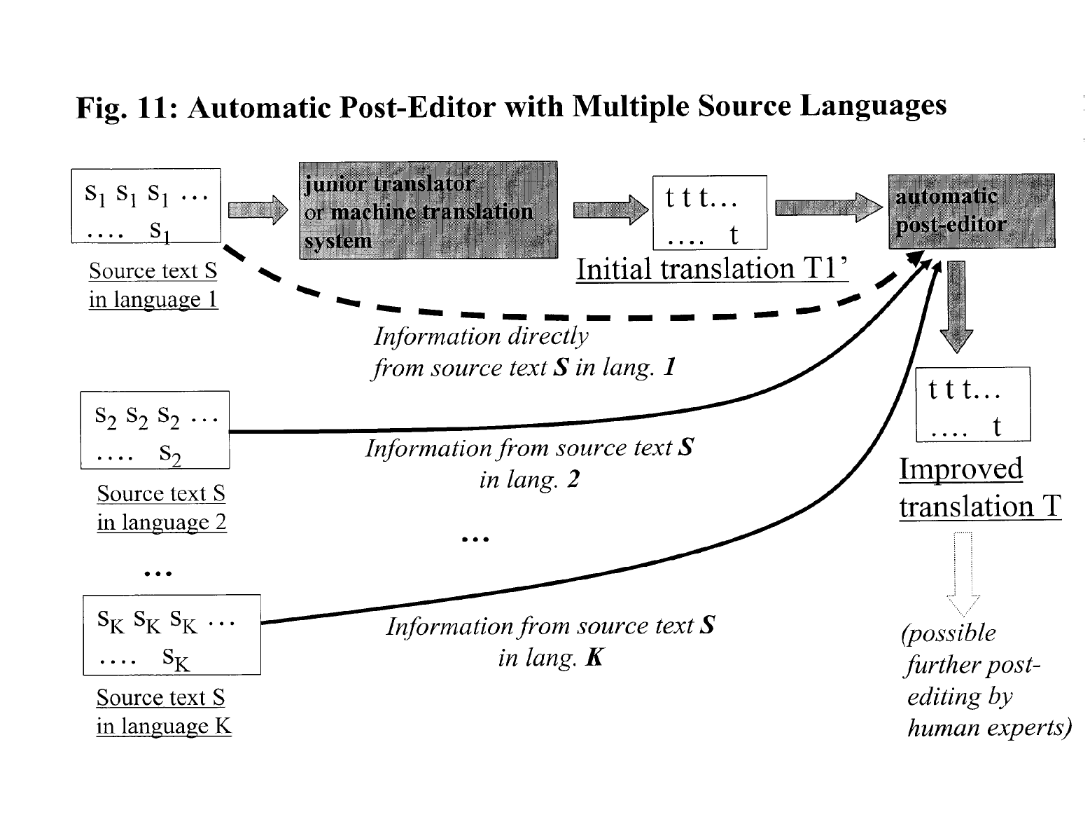

FIG. 11 illustrates yet another possible embodiment of the invention. Consider a situation where high-quality translations of the same source text are available in multiple source languages S₁, S₂, . . . S_{K}, and it is now desired that this text be translated into another language, T. It is easy to see how this situation could arise in practice. For instance, an organization operating in Europe might have had expert human translators produce versions of an important announcement in English, French, and German, and now wishes to quickly produce a version of this document in Estonian, though an expert Estonian translator is either unavailable, or costs too much. Once an initial translation has been produced from one of the source languages—say, from the English version of the announcement into Estonian—it seems intuitively clear that automatic post-editing of this initial translation might benefit from information contained in the other available versions of the announcement (in the example, the French and German versions). Thus given, for instance, an MT system for translating from French to Estonian and another MT system for translating from German to Estonian, a hybrid APE can be used to incorporate information from the English, French and German versions of the source document into the final translation into Estonian.

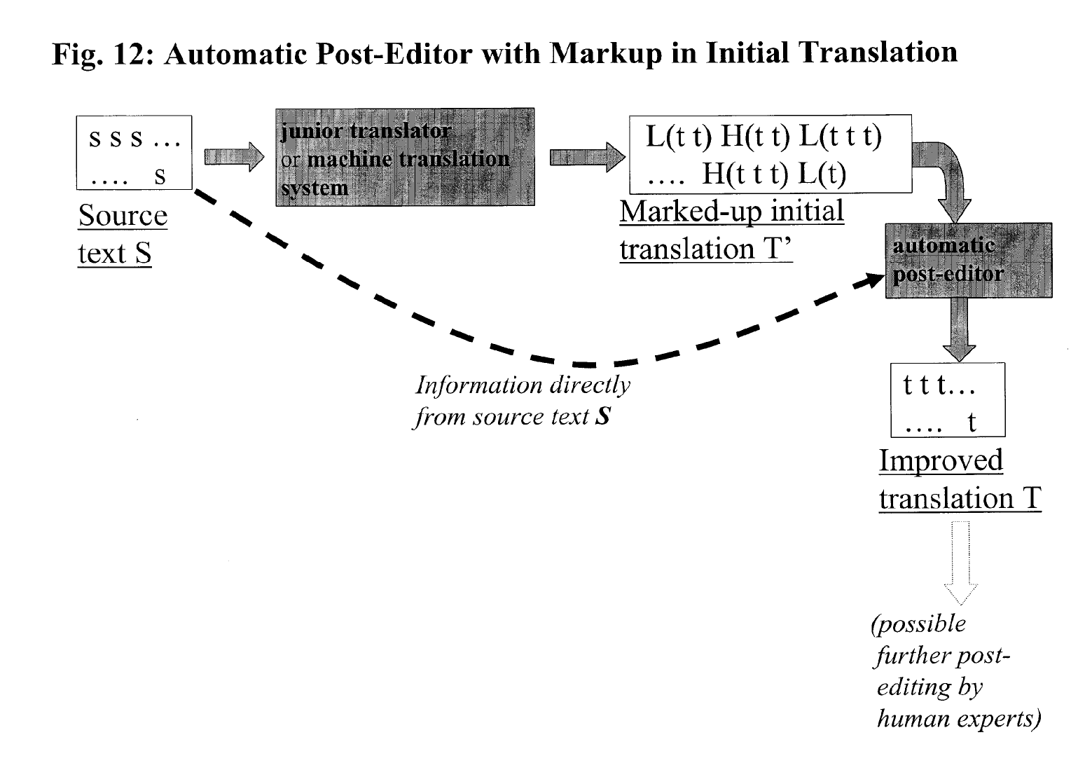

FIG. 12 illustrates an aspect of the invention suitable for situations where some parts of the initial translation are known to be more reliable than others. In such situations, the initial translation can be marked up to indicate which parts of it can be assumed to be correct with high confidence, and which parts are assigned a lower probability of being correct. The figure shows a simple binary classification of the word sequence constituting the initial translation into regions of high confidence (marked “H” in the figure) and regions of low confidence (marked “L” in the figure). However, it would be possible to mark up regions of the initial translation with numerical scores (integers or real numbers) indicating the confidence. The automatic post-editor can be instructed to preserve regions of high confidence unchanged (or only slightly changed) where possible, while freely changing regions of low confidence. An example of how this capability can be useful would occur, for instance, in a case where a rule-based MT system supplying the initial translation is known to translate names and dates with high accuracy, while doing performing less accurately on other kinds of words. In such a case, the rule-based system could mark up names and dates in its output as having high confidence, ensuring that the automatic post-editor would be more conservative in editing these than in editing other regions of the initial translation.

Another important embodiment of the invention not discussed earlier is interactive post-edition. In this embodiment, a human post-editor interacts with an APE to produce the final translation. For instance, the APE might propose alternate ways of correcting an initial translation, from which a human post-editor could make a choice. For collaborative translation environments (e.g., via an Internet-based interface), automatic post-editing might be iterative: an initial MT system proposes initial translations, these are improved by the APE, human beings improve on the translations from the APE, those even better translations are used to retrain the APE, and so on.

In the case of initial translations from multiple initial translators (whether human or machine) the possibility of a specialized APE for each initial translator has already been mentioned. If the initial translators were human, the APE could easily generate a diagnostic report itemizing errors typically made by a particular initial translator.

Other embodiments of the invention, in which the APE could be customized based on specified features. These features could include: For instance, in an organization in which there were several human post-editors, a particular human post-editor might choose to train a particular APE only on post-editions he himself had created. In this way, the APE's usages would tend to mirror his. The APE could be retrained from time to time as larger and larger amounts of post-edited translations from this human post-editor became available, causing the APE's output to reflect the human post-editor's preferences more and more over time. Another form of APE customization would be to train a given APE only on corpora related to a machine identity associated with the machine translation system which performed the initial translation of the source sentence, of the particular genre of document, a particular task to which a document to be transitated is related to, to a particular topic relating to the documents requiring translation, a particular semantic domain, or a particular client.

As explained above, our invention can be embodied in various approaches that belong to the scientific paradigm of statistical machine translation. However, it is important to observe that it can also be embodied in approaches based on other scientific paradigms from the machine learning family.

Furthermore, other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method for creating a sentence aligned parallel corpus used in post-editing; said method comprising the following steps:
a) providing a training source-language sentence;
b) translating the training source-language sentence into a first training target-language sentence;
c) providing a second translation of said training source-language sentence called a training target-language sentence, said second training target-language sentence being independently translated from said source sentence;
d) creating a sentence pair made of said first training target-language sentence and said second training target-language sentence;
e) storing said sentence pair in a sentence aligned parallel corpus;
f) repeating steps a) to e) for one or more than an additional source training-language sentence;
g) outputting the sentence aligned parallel corpus.

2. The method of claim 1 comprising the additional step of training a post-editor using said sentence aligned parallel corpus.

3. The method of claim 1 where translating said training source-language sentence into a first training target-language sentence is performed by a machine translation system.

4. The method of claim 3 where said machine translation system is rule-based.

5. The method of claim 1 where said second training target-language sentence was translated by a human being.

6. The method of claim 5 where training said post-editor is customized using one or more than one specific feature, where said feature is selected from a group comprising:
a human being identity of the human being having translated the second training target language sentence;
a machine identity of the machine translation system having translated the training source-language sentence into a first training target-language sentence;
a genre of a document to be translated,
a task to which a document to be translated is related,
a topic of a document to be translated,
a semantic domain of a document to be translated,
a client for whom a document is to be translated.

7. A method for automatically post editing an initial translation of a source language text comprising of the steps:
a) providing a source-language sentence;
b) translating said source-language sentence into an initial target-language sentence;
c) providing a sentence aligned parallel corpus created from one or more than one sentence pair target-language sentence, each pair comprising of a first training target-language sentence and a second independently generated training target-language sentence;
d) automatically post-editing the initial target-language sentence using a post-editor trained on said sentence aligned parallel corpus;
e) outputting from said automatic post-editing step one or more than one improved target-language sentence hypotheses.

8. The method of claim 7 where translating said source-language sentence into an initial target-language sentence is performed by a rule based machine translation system.

9. The method of claim 7 or 8 where automatically post-editing the initial target-language sentence is performed by a machine translation system.

10. The method of claim 9 where automatically post-editing the initial target-language sentence is performed by a statistical machine translation system.

11. The method of claim 7 where automatically post-editing the initial target-language sentence is performed while considering one or more than one source-language sentences in different languages.

12. The method of claim 7 comprising the additional steps:
f) generating a first target-language model with said outputted higher quality target sentence hypotheses;
g) providing one or more than one additional target-language models;
h) inputting said source sentence, said first target-language model and one or more than one additional target-language models in a modified decoder;
i) outputting one or more than one final target-language sentence hypothesis.

13. The method of claim 7 where a portion of the initial target-language sentence is attributed a confidence rating, said confidence rating influencing the probability of said portion being post-edited.

14. The method of claim 13 where the confidence rating is either a high or a low rating.

15. The method of claim 13 where said confidence rating is a numerical score.

16. The method of claim 7, 11 where automatically post-editing the initial target-language sentence is performed while taking said source-language sentence into consideration.

17. A method for translating a source sentence comprising the steps:
a) providing a source-language sentence; b) translating said source-language sentence into one or more than one target-language sentence hypothesis using statistical machine translation;
c) translating said source-language sentence into one or more than one initial target-language sentence using one or more than one machine translation system;
d) post-editing said one or more than one initial target-language sentence;
e) outputting an improved initial target-language sentence from the post-editing step;
f) selecting from said target-language sentence hypotheses and from said higher quality initial target-language sentence hypotheses a final target-language sentence hypothesis, said selecting step done based on the score associated with each hypothesis;
g) outputting said final target-language hypothesis sentence as said final target-language sentence.

18. The method of claim 17 where said automatic post-editor was trained using a sentence aligned parallel corpus, said sentence aligned parallel corpus created by;
a) providing a training source-language sentence;
b) translating the training source-language sentence into a first training target-language sentence;
c) providing a second translation of said training source-language sentence called a training target-language sentence, said second training target-language sentence being independently translated from said source-language sentence;
d) creating a sentence pair made of said first training target-language sentence and said second training target-language sentence;
e) storing said sentence pair in a sentence aligned parallel corpus;
f) repeating steps a) to e) for one or more than one new training source-language sentence;
g) outputting a sentence aligned parallel corpus;

19. A method for translating a source sentence into a final target sentence comprising the steps:
a) providing a source-language sentence;
b) translating with a statistical machine translation system said source-language sentence into one or more than one target-language sentence hypothesis;
c) translating said source-language sentence into one or more than one initial target-language sentence;
d) post-editing said initial target-language sentence with an automatic post editor to form one or more than one improved target-language sentence hypothesis;
e) creating a hybrid hypothesis from said one or more than one initial target-language sentence hypothesis and one or more than one improved target-language sentence hypothesis with a recombiner;
f) selecting the hypothesis having the highest probability created by the recombiner;
g) outputting said final translation.

20. The method of claim 19 where said automatic post-editor was trained using a sentence aligned parallel corpus, said sentence aligned parallel corpus created by;
a) providing a training source-language sentence;
b) translating the training source-language sentence into a first training target-language sentence;
c) providing a second translation of said training source-language sentence called a training target-language sentence, said second training target-language sentence being independently translated from said source sentence;
d) creating a sentence pair made of said first training target-language sentence and said second training target-language sentence;
e) storing said sentence pair in a sentence aligned parallel corpus;
f) repeating steps a) to e) for one or more than one new source training-language sentence;
g) outputting a sentence aligned parallel corpus;

21. A method for automatically post editing an initial translation of a source-language text comprising of the steps:
a) providing a source-language sentence;
b) translating said source-language sentence into an initial target-language sentence;
c) inputting said source-language sentence and said initial target-language sentence into a modified statistical machine translation decoder;
d) outputting from said decoder one or more than one hypotheses of a improved translation.

22. The method of claim 21 where said decoder consults one or more than one phrase table and language models.

23. The method of claim 22 where said one or more than one phrase table comprises a target-to-source-translation table and an initial translation to a second translation table.

24. The method of claim 22 where said one or more than one phrase table comprises a three way phrase table.

25. A computer readable memory comprising a post-editor, said post-editor comprising a;
an automatic post-editing means where such a post-editing means has been trained on a sentence aligned parallel corpus trained on a first training target-language sentence and
a second independently generated training target-language sentence;
an outputting means for outputting one or more than one final target-language sentence hypotheses.
